(19) United States
(12) Patent Application Publication
(10) Pub. No.: US 2010/0037185 A1
(43) Pub. Date: Feb. 11, 2010

(54) INPUT METHOD FOR COMMUNICATION DEVICE

(75) Inventor: JIAN-SHENG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/502,186

(22) Filed: Jul. 13, 2009

(30) Foreign Application Priority Data
Aug. 7, 2008 (CN) 200810303578.9

(51) Int. Cl. G06F 3/033

(52) U.S. Cl. 715/863

(57) ABSTRACT

An input method for a communication device includes the steps of displaying a result box and a dial ring comprising a plurality of buttons on a touch screen of the communication device; receiving a touch and slide operation on a button; recognizing the touch and slide operation and rotating the dial ring according to the slide operation; and displaying information represented by the touched button in the result box when the touched button rotates to a predetermined position. People who are used to rotary dial phone can use the input method without difficulty.

### BACKGROUND

1. Technical Field

The present disclosure relates to an input method using a touch screen and, particularly, to an input method using a touch screen of a communication device.

2. Description of Related Art

More and more communication devices, such as mobile phones, adapt touch screens as input units. The touch screen normally shows a plurality of buttons. People just touch the buttons for inputting operations. Yet, some people, especially old persons who are used to rotary dial telephones, may not easily become accustomed to inputting using a touch screen.

What is disclosed here is an input method used on a touch screen of a communication device, the input method simulates the input method used with a rotary dial telephone.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, front view of a communication device according to an exemplary embodiment.

FIG. 2 is a flowchart showing an input method used in the communication device of FIG. 1 according to an exemplary embodiment.

FIGS. 3 and 4 are schematic diagram of the communication device of FIG. 1, showing the process of inputting a number into the communication device.

### DETAILED DESCRIPTION

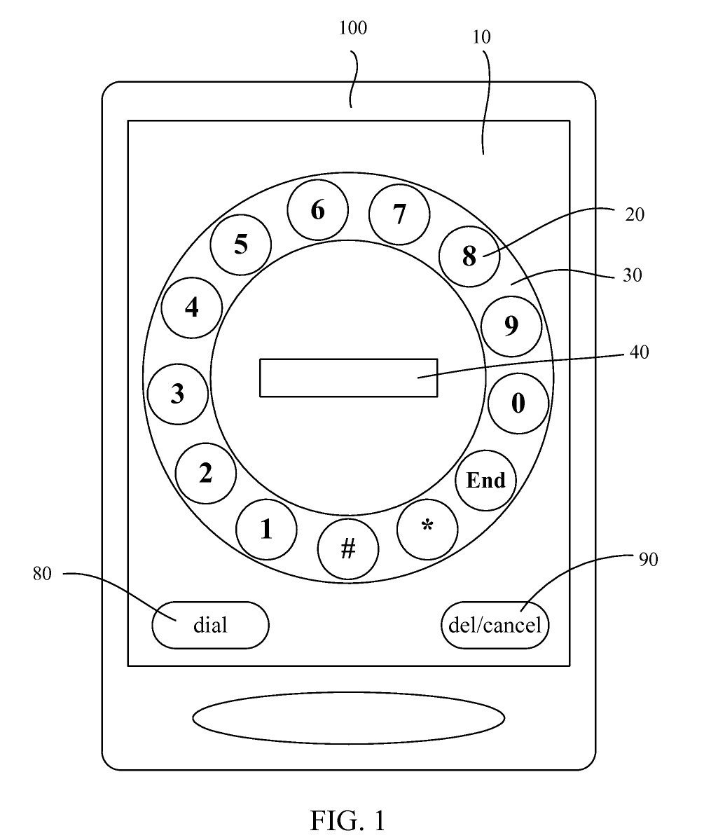

Referring to FIG. 1, a communication device 100 is disclosed. The communication device 100 includes a touch screen 10. The touch screen 10 displays a plurality of buttons 20. Some of the buttons 20 show numbers, including “1”, “2”, “3”, “4”, “5”, “6”, “7”, “8”, “9”, and “0”. The other buttons 20 show function symbols, including “*”, “#”, and “End”. The buttons 20 are evenly arranged in a circle forming a dial ring 30. A result box 40 is disposed within the dial ring 30. The result box 40 is used for showing results of operations via the buttons 20, for example, showing a phone number input by operating the buttons 20. The touch screen 10 also displays a dial button 80 and a del/cancel button 90 outside the dial ring 30. The dial button 80 is used for calling the phone number shown in the result box 40. The del/cancel button 90 is used for deleting results shown in the result box 40.

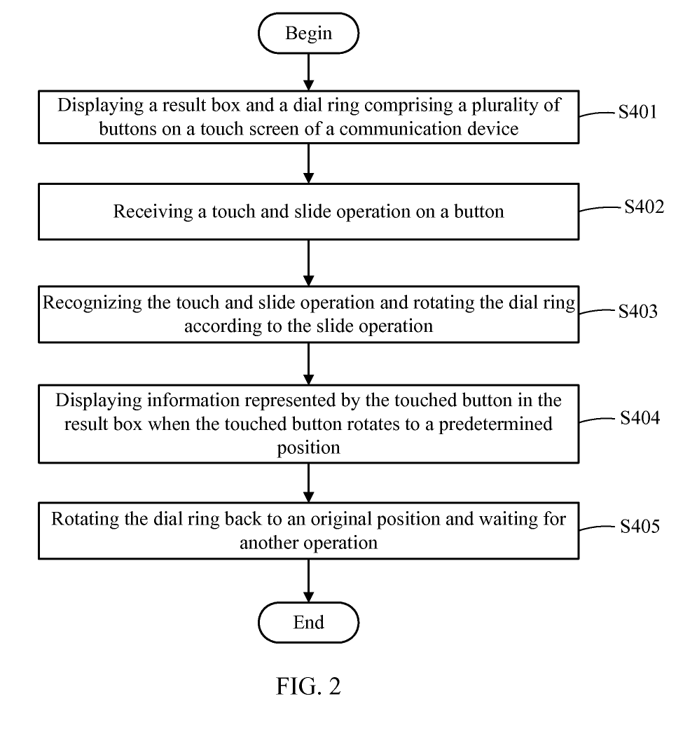

Referring to FIG. 2, an input method based on the communication device 100 is shown. The input method includes steps described below.

In step S401, the communication device 100 shows the dial ring 30 and the result box 40 on the touch screen 10.

In step S402, the communication device 100 receives a user's touch and slide operation on a button 20 of the dial ring 30.

In step S403, the communication device 100 recognizes the user's touch and slide operation and controls the dial ring 30 on the touch screen to rotate according to the slide operation of the user. Specifically, the communication device controls the rotation direction of the dial ring 30 to be consistent to the direction of the slide operation, and the speed of rotation of the dial ring 30 to be consistent with the speed of the slide operation. For example, if the user slides in a circular motion left or anticlockwise, the communication device 100 controls the dial ring 30 to rotate anticlockwise, and if the user slides in a circular motion right or clockwise, the communication device 100 controls the dial ring 30 to rotate clockwise.

In step S404, the communication device 100 recognizes that the touched button 20 rotates to a predetermined position, the communication device displays information represented by the button 20 on the result box 40.

In step S405, the communication device 100 controls the dial ring 30 to rotate back to the original position and wait for another operation.

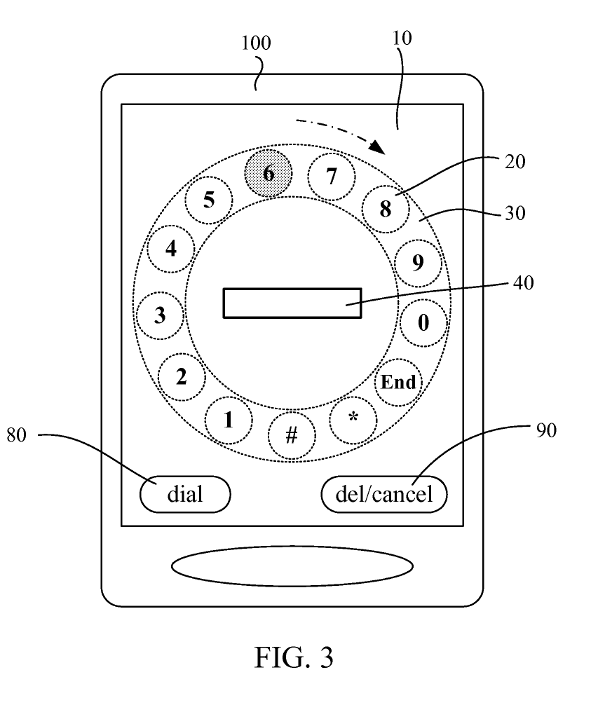

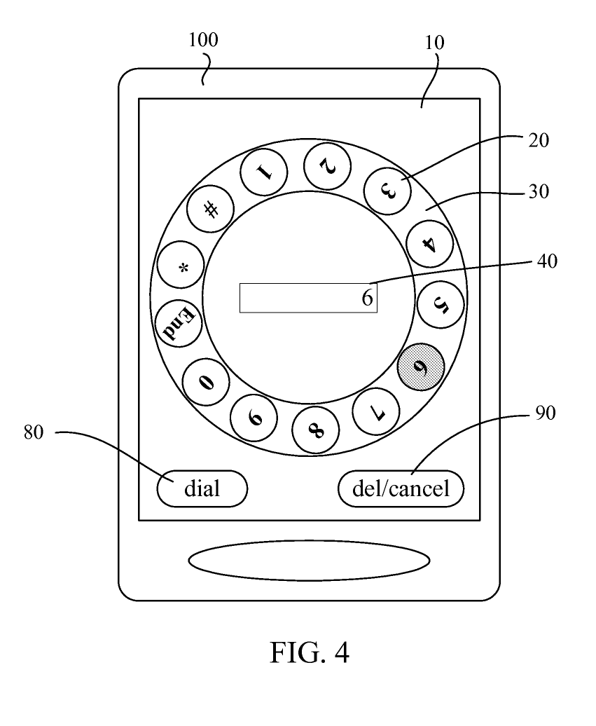

Referring to FIGS. 3 and 4, an example of using the communication device 100 with the input method is shown. In FIG. 3, the “End” button 20 represents the predetermined position. A user touches the “6” button 20, and then slides on the touch screen 10 clockwise to the predetermined position. The dial ring 30 rotates clockwise. In FIG. 4, the “6” button 20 rotates to the predetermined position, and the number “6” is shown in the result box 40 by the communication device 100.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An input method for a communication device, the input method comprising the steps of:
displaying a result box and a dial ring comprising a plurality of buttons on a touch screen of the communication device;
receiving a touch and slide operation on a button;
recognizing the touch and slide operation and rotating the dial ring according to the slide operation; and
displaying information represented by the touched button in the result box when the touched button rotates to a predetermined position.

2. The input method of claim 1, further comprising the step of rotating the dial ring back to an original position and waiting for another operation.

3. The input method of claim 1, wherein the speed of rotation of the dial ring is consistent to the speed of the slide operation.

4. The input method of claim 1, wherein the plurality of buttons comprise buttons representing the numbers “1”, “2”, “3”, “4”, “5”, “6”, “7”, “8”, “9”, and “0”, respectively.

5. The input method of claim 1, wherein the plurality of buttons comprise function buttons representing function symbols comprising “*”, “#”, and “End”.

6. The input method of claim 5, wherein one of the function buttons represents the predetermined position.

7. The input method of claim 6, wherein the function button for symbol “End” represents the predetermined position.
